(19) United States
(12) Patent Application Publication
(10) Pub. No.: US 2023/0300604 A1
(43) Pub. Date: Sep. 21, 2023

(54) UE CAPABILITY FOR TCI STATE CONFIGURATION OR ACTIVATION

(71) Applicant: QUALCOMM Incorporated, San Diego, CA (US)

(72) Inventors: Yan ZHOU, San Diego, CA (US); Fang YUAN, Beijing (CN); Tao LUO, San Diego, CA (US)

(21) Appl. No.: 18/021,388

(22) PCT Filed: Sep. 9, 2020
(86) PCT No.: PCT/CN2020/114190

§ 371 Date: Feb. 14, 2023

(51) Int. Cl. H04W 8/24

(52) U.S. Cl. CPC H04W 8/24

(57) ABSTRACT

A user equipment (UE) determines a UE capability associated with a joint downlink (DL) and uplink (UL) transmission configuration indicator (TCI) state indicating a common beam for communication in DL and UL and transmits an indication of the UE capability associated with the joint DL and UL TCI state to a base station. The UE may determine a UE capability associated with an UL TCI state for uplink communication and may transmit an indication of the UE capability to the base station. A base station receives the UE capability and configures or activates one or more joint DL and UL TCI states or UL TCI states based on the UE capability.

### BACKGROUND

### Technical Field

The present disclosure relates generally to communication systems, and more particularly, to wireless communication including a transmission configuration indicator (TCI) state.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus determines a UE capability associated with a joint downlink (DL) and uplink (UL) transmission configuration indicator (TCI) state indicating a common beam for communication in DL and UL and transmits, to a base station, an indication of the UE capability associated with the joint DL and UL TCI state.

In another aspect of the disclosure, a method, a computer-readable medium, and an apparatus are provided for wireless communication at a UE. The apparatus determines a UE capability associated with a UL TCI state indicating a beam for communication in UL and transmits, to a base station, an indication of the UE capability associated with the UL TCI state.

In another aspect of the disclosure, a method, a computer-readable medium, and an apparatus are provided for wireless communication at a base station. The apparatus receives, from a UE, an indication of a UE capability associated with a joint DL and UL TCI state indicating a common beam for communication in DL and UL. The apparatus configures or activates one or more joint DL and UL TCI states for the UE based on the UE capability.

In another aspect of the disclosure, a method, a computer-readable medium, and an apparatus are provided for wireless communication at a base station. The apparatus receives, from a UE, an indication of a UE capability associated with an UL TCI state indicating a common beam for UL communication. The apparatus configures or activates one or more UL TCI states for the UE based on the UE capability.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is an example communication flow between a UE and a base station including providing UE capability information relating to a joint DL and UL TCI state.

FIG. 5 is an example communication flow between a UE and a base station including providing UE capability information relating to an UL TCI state.

FIG. 6 is a flowchart of a method of wireless communication.

FIG. 7 is a flowchart of a method of wireless communication.

FIG. 8 is a diagram illustrating an example of a hardware implementation for an example apparatus.

FIG. 9 is a flowchart of a method of wireless communication.

FIG. 10 is a flowchart of a method of wireless communication.

FIG. 11 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

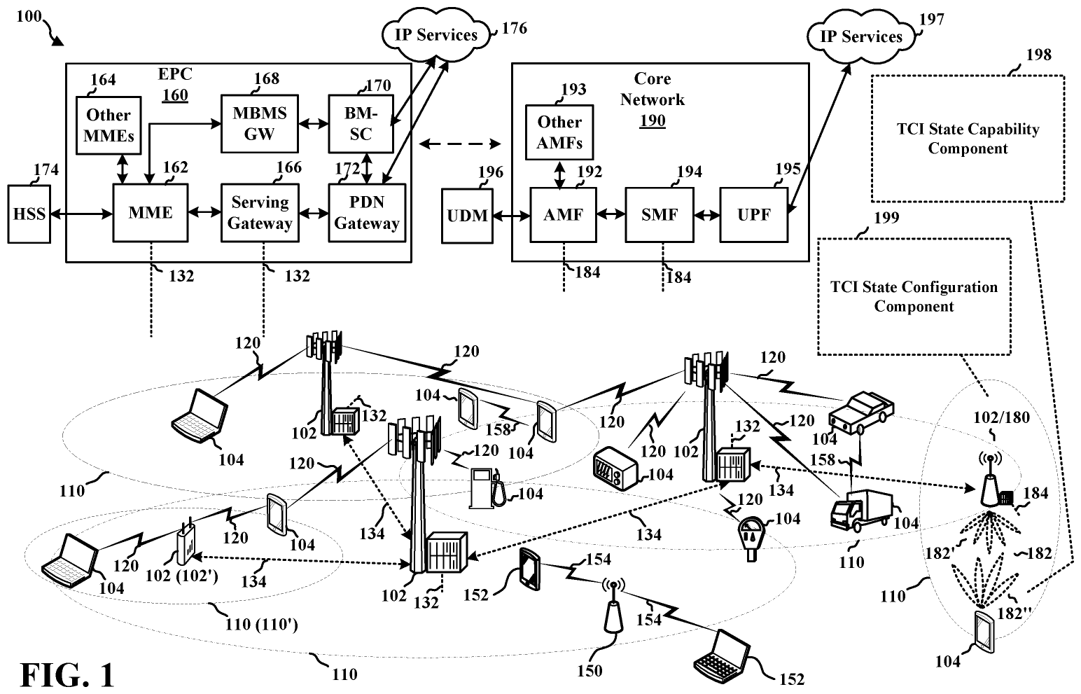

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a TCI state capability component 198 configured to determine a UE capability associated with a joint DL and UL TCI state indicating a common beam for communication in DL and UL. The TCI state capability component 198 may be configured to transmit, to a base station 102 or 180, an indication of the UE capability associated with the joint DL and UL TCI state. In some examples, the TCI state capability component 198 may be configured to determine a UE capability associated with a UL TCI state indicating a beam for communication in UL and transmit, to a base station, an indication of the UE capability associated with the UL TCI state. The base station 102 or 180 may include a TCI state configuration component 199 configured to receive, from a UE, an indication of a UE capability associated with a joint DL and UL TCI state indicating a common beam for communication in DL and UL. The apparatus configures or activates one or more joint DL and UL TCI states for the UE based on the UE capability. In some examples, the TCI state configuration component 199 may be configured to receive, from a UE, an indication of a UE capability associated with an UL TCI state indicating a common beam for UL communication. The apparatus configures or activates one or more UL TCI states for the UE based on the UE capability. Although the following description may be focused on 5G NR, the concepts described herein may be applicable to other similar areas, such as LTE, LTE-A, CDMA, GSM, and other wireless technologies.

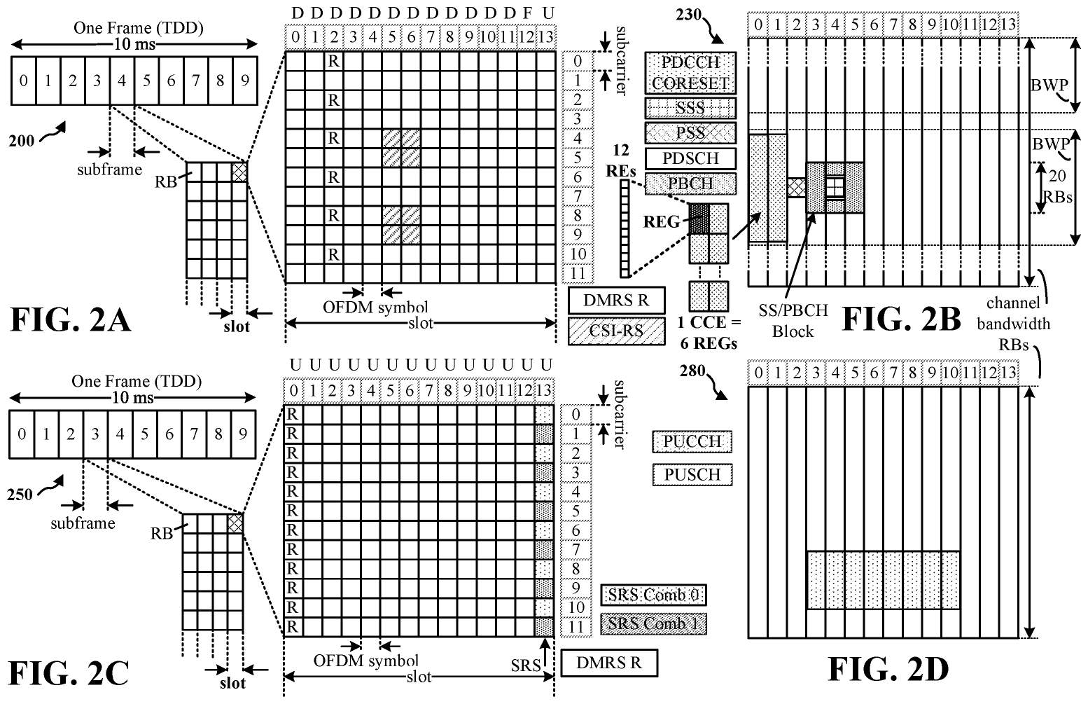

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have different frame structures and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

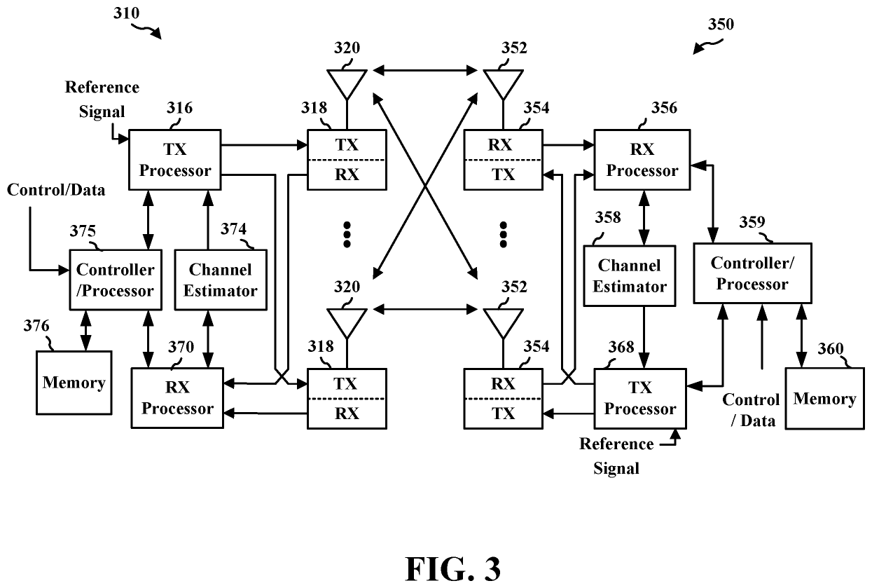

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the TCI state capability component 198 of FIG. 1.

At least one of the TX processor 316, the RX processor 370, and the controller/processor 375 may be configured to perform aspects in connection with the TCI state configuration component 199 of FIG. 1.

There is a need for enhancement on multi-beam operation, e.g., targeting FR2 while also applicable to FR1. To enhance multi-beam operation, features may be identified and specified to facilitate more efficient (lower latency and overhead) DL/UL beam management to support higher intra and L1/L2-centric inter-cell mobility and/or a larger number of configured TCI states. A common beam for data and control transmission/reception for DL and UL, especially for intra-band CA, may be specified in order to provide a unified TCI framework for DL and UL beam indication. Enhancement on signaling mechanisms for the above features to improve latency and efficiency with more usage of dynamic control signaling (as opposed to RRC) may be provided. Further, features may be identified and specified to facilitate UL beam selection for UEs equipped with multiple panels, considering UL coverage loss mitigation due to maximum permissible exposure (MPE), based on UL beam indication with the unified TCI framework for UL fast panel selection.

Aspects presented herein enable a unified TCI framework for DL and UL beam indication. The unified TCI framework may be used to signal a common beam for multiple DL and UL resources to save both beam indication and overhead latency. The common beam indication may be signaled via a joint DL/UL TCI state. The activation of a joint DL/UL TCI state in case of a single DCI scheduling DL/UL with multiple TRPs is described herein.

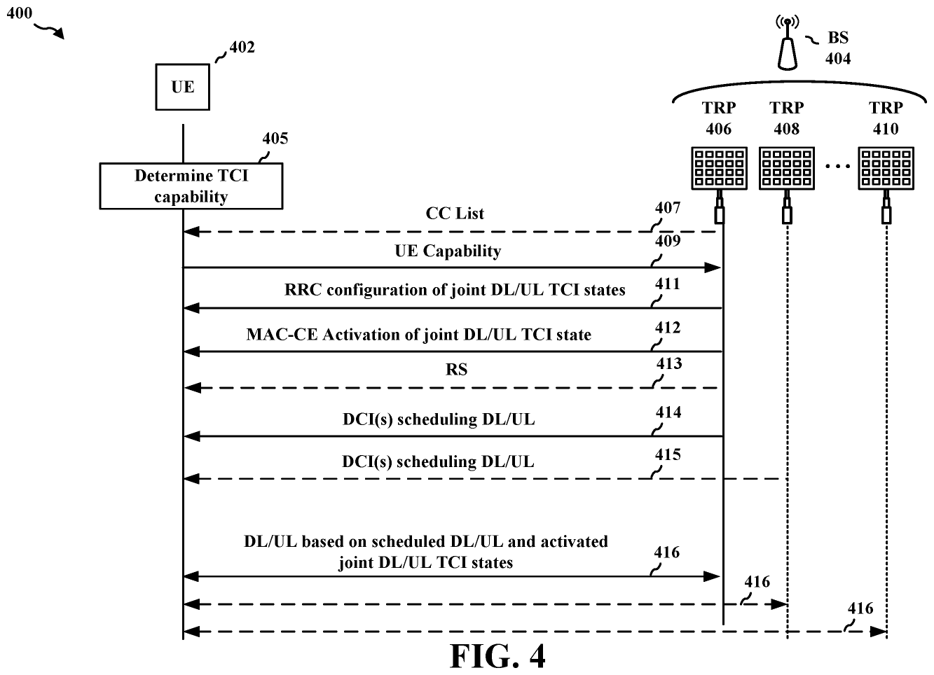

FIG. 4 is a call-flow diagram 400 illustrating activation of joint DL/UL TCI states for DL and/or UL communication between a UE 402 and a base station 404.

In some examples, the UE may communicate with multiple TRPs (e.g., 406, 408, 410) in association with a single scheduling DCI 414 from one TRP 406 scheduling a UE 402 with DL/UL with multiple TRPs 406, 408, 410 of the base station (BS) 404. Although TRP 406 is used as example here, the MAC-CE 412 or DCI 414 can be transmitted from any of other TRPs, e.g., TRP 408 or 410 which are associated with BS 404. In some examples, the UE 402 may communicate with the base station 404 via multiple TRPs (e.g., 406, 408, 410) based on multiple DCIs, e.g., DCI 414 and 415. In some examples, the UE may communicate with the base station via a single TRP 406.

The UE may determine, at 407, a UE capability related to a joint DL/UL TCI state for communication with the base station 404 and may indicate the UE capability 409 to the base station 404. The base station 404 may use the UE capability 409 to configure the UE 402 for one or more joint DL/UL TCI states, at 411. For example, the base station 404 may configure a set of joint DL/UL TCI states in RRC signaling for the UE 402. The base station 404 may activate one or more joint DL/UL TCI state for the UE, at 412. For example, the base station may transmit a MAC-CE or other downlink signal indicating one or more of the configured joint DL/UL TCI states that are activated for the UE. Each activated joint DL/UL TCI state indicates a common beam (receive (Rx)/transmit (Tx) beam) for communication in DL/UL. The UE 402 receives, from the TRP 406, one or more DCIs 414 and/or 415 scheduling the communication through the DL/UL with at least one of the TRPs 406, 408, and/or 410. The UE 402 communicates 416 through the scheduled DL/UL with at least one of the TRPs 406, 408, and/or 410 based on the activated joint DL/UL TCI states.

In some examples, the UE 402 may indicate a UE capability 409 for a single TRP (e.g., TRP 406). The UE capability 409 may include any of a maximum number of configured joint DL and UL TCI states per bandwidth part (BWP) per component carrier (CC), a maximum number of activated joint DL and UL TCI states per BWP per CC, a maximum number of configured joint DL and UL TCI states across all CCs, and/or a maximum number of activated joint DL and UL TCI states across all CCs. The UE capability 409 may be for data and control in downlink and uplink. In some examples, the base station 404 may configure one or more CC lists 407 for the UE. The base station 404 may configured the CC lists(s) 407 in RRC signaling to the UE 402. The UE 402 may indicate the UE capability 409 for the maximum number of configured joint DL and UL TCI states across all CCs in the configured CC list(s) and/or the maximum number of activated joint DL and UL TCI states across all CCs in the configured CC list(s).

In some examples, the UE 402 may indicate the UE capability 409 for multiple DCI (multi-DCI) based multiple TRPs (e.g., TRP 406 and 406 that send DCI 414 and 415, respectively). Such communication may be referred to as multi-DCI based multi-TRP communication, where the UE is scheduled by different DCIs to transmit or receive signals associated with different TRPs. The UE capability 409 may indicate any of a maximum number of configured joint DL and UL TCI states per control resource set (CORESET) pool index per bandwidth part (BWP) per component carrier (CC), a maximum number of activated joint DL and UL TCI states per CORESET pool index per BWP per CC, a maximum number of configured joint DL and UL TCI states across all CORESET pool indexes per BWP per CC, a maximum number of activated joint DL and UL TCI states across all CORESET pool indexes per BWP per CC, a maximum number of configured joint DL and UL TCI states per CORESET pool index across all CCs, a maximum number of activated joint DL and UL TCI states per CORESET pool index across all CCs, a maximum number of configured joint DL and UL TCI states across all CORESET pool indexes across all CCs, a maximum number of activated joint DL and UL TCI states across all CORESET pool indexes across all CCs, a first support of a default DL and UL TCI state per CORESET pool index per BWP per CC, and/or a second support of the default DL and UL TCI state per CORESET pool index across all CCs. The UE capability 409 may be for data and control in downlink and uplink. In some examples, the base station 404 may configure one or more CC lists 407 for the UE. The UE capability 409 may be indicated for the CCs in the CC lists(s) 407. For example, the UE may indicate a capability for a maximum number of configured joint DL and UL TCI states per CORESET pool index across all CCs in the CC list(s), the maximum number of activated joint DL and UL TCI states per CORESET pool index across all CCs in the CC list(s), the maximum number of configured joint DL and UL TCI states across all CORESET pool indexes across all CCs in the CC list(s), the maximum number of activated joint DL and UL TCI states across all CORESET pool indexes across all CCs in the CC list(s), and/or the support of the default DL and UL TCI state per CORESET pool index across all CCs in the CC list(s).

In some examples, the UE 402 may indicate the UE capability 409 for a plurality of TRPs (e.g., TRP 406, 408, and/or 410) based on a single DCI 414. Such communication may be referred to as single-DCI based multi-TRP communication, where the UE is scheduled by a single DCI to transmit or receive signals associated with different TRPs. The UE 402 may indicate the UE capability 409 for any of a maximum number of configured joint DL and UL TCI states mapped to a TCI codepoint for a resource allocation scheme across the multiple TRPs scheduled by a scheduling DCI, support of a default TCI codepoint mapped to multiple joint DL and UL TCI states per BWP per CC, and/or support of the default TCI codepoint mapped to the multiple joint DL and UL TCI states across all CCs. The maximum number of joint DL/UL TCI states mapped to one TCI codepoint may be indicated by the UE for different schemes for resource allocation across multiple TRPs scheduled by the scheduling DCI. The different schemes may include any of frequency division multiplexing (FDM), spatial division multiplexing (SDM), or time division multiplexing (TDM). The maximum number may be indicated for a mini-slot based TDM scheme or a slot based TDM scheme, for example. In some examples, the base station 404 may configure one or more CC lists 407 for the UE. The UE capability 409 may be indicated for the CCs in the CC lists(s) 407. For example, the UE 402 may indicate the UE capability 409 for support of the default TCI codepoint mapped to the multiple joint DL and UL TCI states across all CCs in the configured CC list(s). The default TCI codepoint may be applied to the scheduled transmissions or receptions associated with the TRPs, where the TCIs associated with the scheduled transmissions or receptions are not explicitly indicated, and the TCIs mapped to the default TCI codepoints are applied to the corresponding scheduled transmissions or receptions.

In some examples, the UE 402 may indicate the UE capability 409 for simultaneous joint DL/UL TCI state activation across CCs. The UE 402 may support activation of the joint DL/UL TCI state across multiple CCs. For example, if the base station 404 activates a joint DL/UL TCI state for a CC in one of the configured CCL lists 407, the UE 402 may support applying the joint DL/UL TCI state to each of the CCs in the configured list.

The UE 402 may indicate the UE capability 409 for layer 1 (L1) or layer 2 (L2) based inter-cell mobility based on the joint DL and UL TCI state. For example, the UE may support a reference signal or a channel of a non-serving cell for the joint DL and UL TCI state. The reference signal or the channel of the non-serving cell may provide various DL quasi co-location (QCL) assumptions or uplink spatial relation information for the joint DL and UL TCI state.

The UE 402 may indicate a UE capability 409 for an update of the joint DL and UL TCI state via at least one of a MAC-CE or DCI. The update may correspond to the activation/deactivation of the joint DL and UL TCI state in a MAC-CE message or in DCI. The UE may indicate support for DCI based joint DL/UL TCI state updates. The UE 402 may indicate support for MAC-CE based joint DL/UL TCI state updates.

The UE 402 may indicate the UE capability 409 for a subset of one or more channels and/or for a subset of one or more reference signals which can be updated with joint DL/UL TCI state. For example, the UE may indicate the UE capability 409 for one or more of a PDCCH, a PDSCH scheduled by DCI, a semi-persistent scheduling (SPS) transmission, a periodic channel state information reference signal (CSI-RS), a semi-persistent CSI-RS, an aperiodic CSI-RS, a positioning reference signal, a periodic PUCCH, a semi-persistent PUCCH, an aperiodic PUCCH, a PUSCH, a sounding reference signal (SRS), or physical random access channel (PRACH).

In some examples, SRS may be a source RS in a downlink only TCI state or the joint DL/UL TCI state to indicate a UE spatial reception (Rx) filter. The UE spatial reception (Rx) filter may indicate a QCL Type D assumption, e.g., based on the UE capability 409. The SRS served as the source RS may be the SRS for different information purposes, e.g., including SRS configured for any of beam management (BM), codebook (CB) based communication (e.g., CB based uplink MIMO transmission), non-codebook (NCB) based communication (e.g., NCB based uplink MIMO transmission), and/or antenna switching (e.g., for downlink CSI acquisition). In some examples, the TCI state (e.g., a joint DL/UL TCI state) based on the SRS as a QCL-Type D reference signal may not include other source reference signals to provide other QCL assumptions, e.g., QCL Type A, QCL Type B, or QCL Type C assumptions. In some examples, the TCI state (e.g., a joint DL/UL TCI state) based one the SRS as a QCL Type D reference signal may indicate one or more other reference signals to provide other QCL assumptions (e.g., QCL Type A, QCL Type B, or QCL Type C assumptions) for the DL/UL communication based on the TCI state.

The base station 404 may configure one or more joint DL/UL TCI states for the UE 402, at 411, based on the UE capability 409 information provided by the UE. The base station 404 may activate at least one joint DL/UL TCI state for the UE 402 based on the UE capability 409 information received from the UE 402. In some examples, the TCI state may be associated with a reference signal 413 from the base station 404. The base station 404 may schedule downlink and/or uplink communication with the UE 402, e.g., using DCI 414 and/or 415. The UE 402 and the base station 404 may exchange downlink and/or uplink communication 416 based on the active DL and UL TCI state and the resources scheduled by the DCI 414 and/or 415.

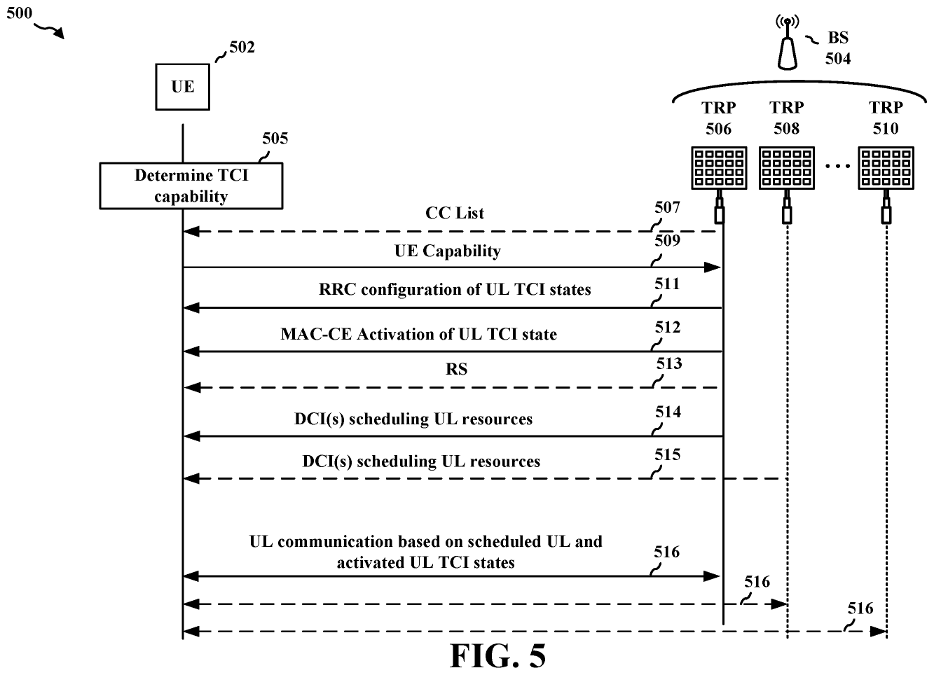

FIG. 5 illustrates an example communication flow between a UE 502 and a base station 504 including an indication of a UE capability 509 associated with an UL TCI state. Similar to FIG. 4, the UE may communicate with a single TRP or with multiple TRPs (e.g., 406, 408, 410). Multiple TRP communication may be based on a single DCI 514 or multiple DCI 514 and 515.

The UE may determine, at 507, a UE capability related to an UL TCI state for communication with the base station 504 and may indicate the UE capability 509 to the base station 504. The base station 504 may use the UE capability 509 to configure the UE 502 for one or more UL TCI states, at 511. For example, the base station 504 may configure a set of UL TCI states in RRC signaling for the UE 502 based on the UE capability 509. The base station 504 may activate one or more UL TCI state for the UE, at 512, based on the UE capability 509. For example, the base station may transmit a MAC-CE or other downlink signal indicating one or more of the configured UL TCI states that are activated for the UE. Each activated UL TCI state indicates a beam (transmit (Tx) beam) for uplink communication. The UE 502 receives, from the TRP 506, one or more DCIs 514 and/or 515 scheduling resources for the uplink communication with at least one of the TRPs 506, 508, and/or 510. The UE 502 transmits uplink communication 516 on the scheduled UL resources with at least one of the TRPs 506, 508, and/or 510 based on the activated UL TCI state.

In some examples, the UE 502 may indicate a UE capability 509 for a single TRP (e.g., TRP 506). The UE capability 509 may include any of a maximum number of configured UL TCI states per bandwidth part (BWP) per component carrier (CC), a maximum number of activated UL TCI states per BWP per CC, a maximum number of configured UL TCI states across all CCs, and/or a maximum number of activated UL TCI states across all CCs. The UE capability 509 may be for data and control in downlink and uplink. In some examples, the base station 504 may configure one or more CC lists 507 for the UE. The base station 504 may configured the CC lists(s) 507 in RRC signaling to the UE 502. The UE 502 may indicate the UE capability 509 for the maximum number of configured UL TCI states across all CCs in the configured CC list(s) and/or the maximum number of activated UL TCI states across all CCs in the configured CC list(s).

In some examples, the UE 502 may indicate the UE capability 509 for multiple DCI (multi-DCI) based multiple TRPs (e.g., TRP 506 and 506 that send DCI 514 and 515, respectively). Such communication may be referred to as multi-DCI based multi-TRP communication. The UE capability 509 may indicate any of a maximum number of configured UL TCI states per control resource set (CORESET) pool index per bandwidth part (BWP) per component carrier (CC), a maximum number of activated UL TCI states per CORESET pool index per BWP per CC, a maximum number of configured UL TCI states across all CORESET pool indexes per BWP per CC, a maximum number of activated UL TCI states across all CORESET pool indexes per BWP per CC, a maximum number of configured UL TCI states per CORESET pool index across all CCs, a maximum number of activated UL TCI states per CORESET pool index across all CCs, a maximum number of configured UL TCI states across all CORESET pool indexes across all CCs, a maximum number of activated UL TCI states across all CORESET pool indexes across all CCs, a support of a default UL TCI state per CORESET pool index per BWP per CC, and/or a support of the default UL TCI state per CORESET pool index across all CCs. The UE capability 509 may be for data and control in downlink and uplink. In some examples, the base station 504 may configure one or more CC lists 507 for the UE. The UE capability 509 may be indicated for the CCs in the CC lists(s) 507. For example, the UE may indicate a capability for a maximum number of configured UL TCI states per CORESET pool index across all CCs in the CC list(s), the maximum number of activated UL TCI states per CORESET pool index across all CCs in the CC list(s), the maximum number of configured UL TCI states across all CORESET pool indexes across all CCs in the CC list(s), the maximum number of activated UL TCI states across all CORESET pool indexes across all CCs in the CC list(s), and/or the support of the default UL TCI state per CORESET pool index across all CCs in the CC list(s). The default TCI codepoint is applied to the scheduled transmissions associated with the TRPs, where the TCIs associated with the scheduled transmissions are not explicitly indicated, and the TCIs mapped to the default TCI codepoints are applied to the corresponding scheduled transmissions.

In some examples, the UE 502 may indicate the UE capability 509 for a plurality of TRPs (e.g., TRP 506, 508, and/or 510) based on a single DCI 514. Such communication may be referred to as single-DCI based multi-TRP communication. The UE 502 may indicate the UE capability 509 for any of a maximum number of configured UL TCI states mapped to a TCI codepoint for a resource allocation scheme across the multiple TRPs scheduled by a scheduled DCI, support of a default TCI codepoint mapped to multiple UL TCI states per BWP per CC, and/or support of the default TCI codepoint mapped to the multiple UL TCI states across all CCs. The maximum number of UL TCI states mapped to one TCI codepoint may be indicated by the UE for different schemes for resource allocation across multiple TRPs scheduled by the scheduling DCI. The different schemes may include any of FDM, SDM, or TDM. The maximum number may be indicated for a mini-slot based TDM scheme or a slot based TDM scheme, for example. In some examples, the base station 404 may configure one or more CC lists 507 for the UE. The UE capability 509 may be indicated for the CCs in the CC lists(s) 507. For example, the UE 502 may indicate the UE capability 509 for support of the default TCI codepoint mapped to the multiple UL TCI states across all CCs in the configured CC list(s).

In some examples, the UE 502 may indicate the UE capability 509 for simultaneous UL TCI state activation across CCs. The UE 502 may support activation of the UL TCI state across multiple CCs. For example, if the base station 504 activates a UL TCI state for a CC in one of the configured CCL lists 507, the UE 502 may support applying the UL TCI state to each of the CCs in the configured list.

The UE 502 may indicate the UE capability 509 for L1 or L2 based inter-cell mobility based on the UL TCI state. For example, the UE may support a reference signal or a channel of a non-serving cell for the UL TCI state. The reference signal or the channel of the non-serving cell may provide various DL QCL assumptions or uplink spatial relation information for the UL TCI state.

The UE 502 may indicate a UE capability 509 for an update of the UL TCI state via at least one of a MAC-CE or DCI. The update may correspond to the activation/deactivation of the UL TCI state in a MAC-CE message or in DCI. The UE may indicate support for DCI based UL TCI state updates. The UE 502 may indicate support for MAC-CE based UL TCI state updates.

The UE 502 may indicate the UE capability 509 for a subset of one or more channels and/or for a subset of one or more reference signals. For example, the UE may indicate the UE capability 509 for one or more of a periodic PUCCH, a semi-persistent PUCCH, an aperiodic PUCCH, a PUSCH, an SRS, or PRACH.

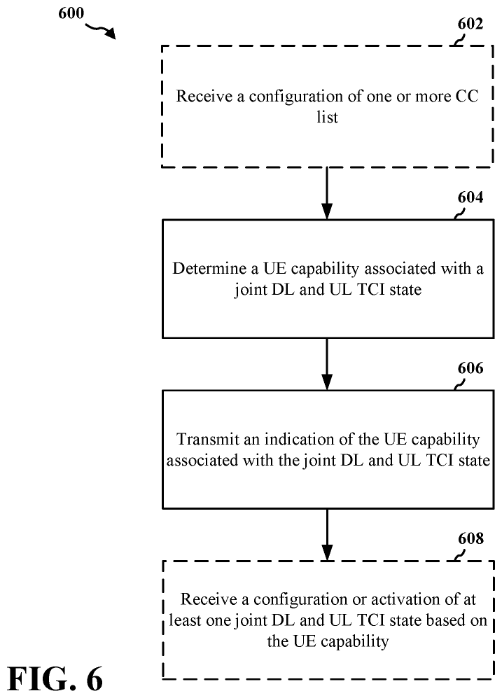

FIG. 6 is a flowchart 600 of a method of wireless communication. The method may be performed by a UE (e.g., the UE 104, 350, 402, 502; the apparatus 802). Optional aspects are illustrated with a dashed line. The method may enable the UE to provide information to a network to assist the network in configuring and/or activating a joint DL and UL TCI state for the UE.

At 604, the UE determines a UE capability associated with a joint DL and UL TCI state indicating a common beam for communication in DL and UL. The determination of the UE capability may be performed, e.g., by the determination component 840 of the communication manager 832 of the apparatus 802.

At 606, the UE transmits an indication of the UE capability associated with the joint DL and UL TCI state to a base station. For example, FIG. 4 illustrates an example of a UE 402 transmitting a UE capability 409 to a base station 404. The transmission of the indication of the UE capability may be performed, e.g., by the TCI state capability component 842 of the communication manager 832 of the apparatus 802.

The UE capability may be for a single TRP and may include at least one of: a first maximum number of configured joint DL and UL TCI states per BWP per CC, a second maximum number of activated joint DL and UL TCI states per BWP per CC, a third maximum number of configured joint DL and UL TCI states across all CCs, or a fourth maximum number of activated joint DL and UL TCI states across all CCs. The UE capability may be for data and control.

As illustrated at 602, the UE may receive a configuration of one or more CC lists, and the UE may report the UE capability, at 606, for the third maximum number of configured joint DL and UL TCI states across all CCs in the one or more CC lists or the fourth maximum number of activated joint DL and UL TCI states across all CCs in the one or more CC lists. The reception of the configuration of the CC list(s) may be performed, e.g., by the CC component 844 of the communication manager 832 of the apparatus 802.

The UE capability may be for multiple downlink control information (multi-DCI) based multiple TRPs and may include at least one of: a first maximum number of configured joint DL and UL TCI states per CORESET pool index per BWP per CC, a second maximum number of activated joint DL and UL TCI states per CORESET pool index per BWP per CC, a third maximum number of configured joint DL and UL TCI states across all CORESET pool indexes per BWP per CC, a fourth maximum number of activated joint DL and UL TCI states across all CORESET pool indexes per BWP per CC, a fifth maximum number of configured joint DL and UL TCI states per CORESET pool index across all CCs, a sixth maximum number of activated joint DL and UL TCI states per CORESET pool index across all CCs, a seventh maximum number of configured joint DL and UL TCI states across all CORESET pool indexes across all CCs, an eighth maximum number of activated joint DL and UL TCI states across all CORESET pool indexes across all CCs, a first support of a default DL and UL TCI state per CORESET pool index per BWP per CC, or a second support of the default DL and UL TCI state per CORESET pool index across all CCs. The UE capability may be for data and control.

As illustrated at 602, the UE may receive a configuration of one or more CC lists, and the UE may report, at 606, the UE capability for at least one of: the fifth maximum number of configured joint DL and UL TCI states per CORESET pool index across all CCs in the one or more CC lists, the sixth maximum number of activated joint DL and UL TCI states per CORESET pool index across all CCs in the one or more CC lists, the seventh maximum number of configured joint DL and UL TCI states across all CORESET pool indexes across all CCs in the one or more CC lists, the eighth maximum number of activated joint DL and UL TCI states across all CORESET pool indexes across all CCs in the one or more CC lists, or the second support of the default DL and UL TCI state per CORESET pool index across all CCs.

The UE capability may be for single DCI based multiple TRPs and may include at least one of: a maximum number of configured joint DL and UL TCI states mapped to a TCI codepoint for a resource allocation scheme across the multiple TRPs scheduled by a scheduled DCI, first support of a default TCI codepoint mapped to multiple joint DL and UL TCI states per BWP per CC, or second support of the default TCI codepoint mapped to the multiple joint DL and UL TCI states across all CCs. The resource allocation scheme may be based on FDM, SDM, or TDM, for example.

As illustrated at 602, the UE may receive a configuration of one or more CC lists, and the UE may report the UE capability for the second support of the default TCI codepoint mapped to the multiple joint DL and UL TCI states across all CCs in the one or more CC lists.

The UE capability may be for activation of the joint DL and UL TCI state across multiple CCs. As illustrated at 602, the UE may receive a configuration of one or more CC lists, and the UE may report the UE capability, at 606, for the activation of the joint DL and UL TCI state across the multiple CCs of the one or more CC lists.

The UE capability may include an L1 or L2 based inter-cell mobility based on the joint DL and UL TCI state. The UE capability may include support for a reference signal or a channel of a non-serving cell for the joint DL and UL TCI state. The reference signal or the channel of the non-serving cell may provide one or more of a DL quasi co-location assumption or uplink spatial relation information for the joint DL and UL TCI state.

The UE capability may be for an update of the joint DL and UL TCI state via at least one of a MAC-CE or DCI. The UE capability may be for one or more of a PDCCH, a PDSCH scheduled by DCI, an SPS transmission, a PRS, a periodic CSI-RS, an aperiodic CSI-RS, a semi-persistent CSI-RS, a periodic PUCCH, an aperiodic PUCCH, a semi-persistent PUCCH, a PUSCH, an SRS, and/or a PRACH.

The UE capability may be associated with an SRS as a source reference signal. The SRS may be the source reference signal for downlink communication, e.g., downlink only. The joint DL and UL TCI state may indicate a UE spatial reception filter associated with the SRS and based on the UE capability. The SRS may be for one or more of: beam management, codebook based communication, non-codebook based communication, or antenna switching. The joint DL and UL TCI state may indicate the SRS as a QCL type D reference signal. The joint DL and UL TCI state may further include at least one additional reference signal for a different QCL assumption.

The UE may receive a configuration, activation, and/or deactivation of one or more joint DL and UL TCI states based on the UE capability, at 608. For example, FIG. 4 illustrates examples of the UE 402 being configuration with a set of joint DL and UL TCI states based on the UE capability, and illustrates the UE receiving an activation of the joint DL and UL TCI states based on the UE capability. The reception of the joint DL and UL TCI state configuration may be performed, e.g., by the TCI state configuration component 846 of the communication manager 832 in the apparatus 802. The activation/deactivation of the joint DL and UL TCI state may be performed, e.g., by the TCI state activation component 848 of the communication manager 832 in the apparatus 802, in response to an indication to activate/deactivate the joint DL and UL TCI state from the base station 102 or 180.

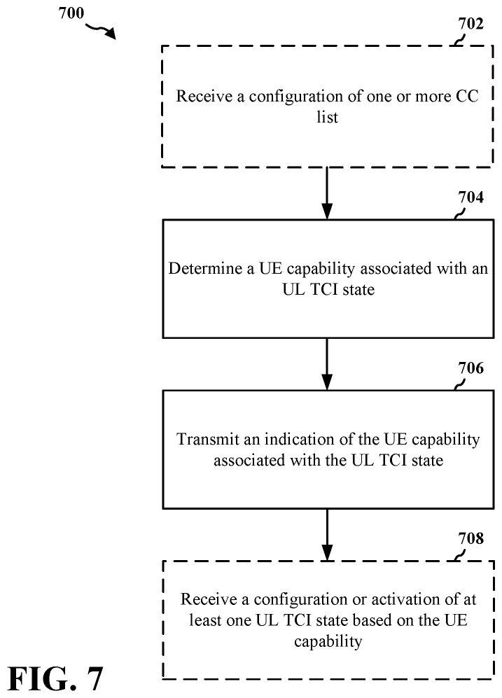

FIG. 7 is a flowchart 700 of a method of wireless communication. The method may be performed by a UE (e.g., the UE 104, 350, 402, 502; the apparatus 802). Optional aspects are illustrated with a dashed line. The method may enable the UE to provide information to a network to assist the network in configuring and/or activating an UL TCI state for the UE.

At 704, the UE determines a UE capability associated with an UL TCI state indicating a beam for uplink communication. The determination of the UE capability may be performed, e.g., by the determination component 840 of the communication manager 832 of the apparatus 802.

At 706, the UE transmits an indication of the UE capability associated with the UL TCI state to a base station. For example, FIG. 5 illustrates an example of a UE 502 transmitting a UE capability 509 to a base station 504. The transmission of the indication of the UE capability may be performed, e.g., by the TCI state capability component 842 of the communication manager 832 of the apparatus 802.

The UE capability may be for a single TRP and may include at least one of: a first maximum number of configured UL TCI states per BWP per CC, a second maximum number of activated UL TCI states per BWP per CC, a third maximum number of configured UL TCI states across all CCs, or a fourth maximum number of activated UL TCI states across all CCs. The UE capability may be for data and control.

As illustrated at 702, the UE may receive a configuration of one or more CC lists, and the UE may report the UE capability, at 706, for the third maximum number of configured UL TCI states across all CCs in the one or more CC lists or the fourth maximum number of activated UL TCI states across all CCs in the one or more CC lists. The reception of the configuration of the CC list(s) may be performed, e.g., by the CC component 844 of the communication manager 832 of the apparatus 802.

The UE capability may be for multiple downlink control information (multi-DCI) based multiple TRPs and may include at least one of: a first maximum number of configured UL TCI states per CORESET pool index per BWP per CC, a second maximum number of activated UL TCI states per CORESET pool index per BWP per CC, a third maximum number of configured UL TCI states across all CORESET pool indexes per BWP per CC, a fourth maximum number of activated UL TCI states across all CORESET pool indexes per BWP per CC, a fifth maximum number of configured UL TCI states per CORESET pool index across all CCs, a sixth maximum number of activated UL TCI states per CORESET pool index across all CCs, a seventh maximum number of configured UL TCI states across all CORESET pool indexes across all CCs, an eighth maximum number of activated UL TCI states across all CORESET pool indexes across all CCs, a first support of a default UL TCI state per CORESET pool index per BWP per CC, or a second support of the default UL TCI state per CORESET pool index across all CCs. The UE capability may be for data and control.

As illustrated at 702, the UE may receive a configuration of one or more CC lists, and the UE may report, at 706, the UE capability for at least one of: the fifth maximum number of configured UL TCI states per CORESET pool index across all CCs in the one or more CC lists, the sixth maximum number of activated UL TCI states per CORESET pool index across all CCs in the one or more CC lists, the seventh maximum number of configured UL TCI states across all CORESET pool indexes across all CCs in the one or more CC lists, the eighth maximum number of activated UL TCI states across all CORESET pool indexes across all CCs in the one or more CC lists, or the second support of the default UL TCI state per CORESET pool index across all CCs.

The UE capability may be for single DCI based multiple TRPs and may include at least one of: a maximum number of configured UL TCI states mapped to a TCI codepoint for a resource allocation scheme across the multiple TRPs scheduled by a scheduled DCI, first support of a default TCI codepoint mapped to multiple UL TCI states per BWP per CC, or second support of the default TCI codepoint mapped to the multiple UL TCI states across all CCs. The resource allocation scheme may be based on FDM, SDM, or TDM, for example.

As illustrated at 702, the UE may receive a configuration of one or more CC lists, and the UE may report the UE capability for the second support of the default TCI codepoint mapped to the multiple UL TCI states across all CCs in the one or more CC lists.

The UE capability may be for activation of the UL TCI state across multiple CCs. As illustrated at 702, the UE may receive a configuration of one or more CC lists, and the UE may report the UE capability, at 706, for the activation of the UL TCI state across the multiple CCs of the one or more CC lists.

The UE capability may include an L1 or L2 based inter-cell mobility based on the UL TCI state. The UE capability may include support for a reference signal or a channel of a non-serving cell for the UL TCI state. The reference signal or the channel of the non-serving cell may provide one or more of a DL quasi co-location assumption or uplink spatial relation information for the UL TCI state.

The UE capability may be for an update of the UL TCI state via at least one of a MAC-CE or DCI. The UE capability may be for one or more of a periodic PUCCH, an aperiodic PUCCH, a semi-persistent PUCCH, a PUSCH, an SRS, and/or a PRACH.

The UE may receive a configuration, activation, and/or deactivation of one or more UL TCI states based on the UE capability, at 708. For example, FIG. 5 illustrates examples of the UE 502 being configuration with a set of UL TCI states based on the UE capability, and illustrates the UE receiving an activation of the UL TCI states based on the UE capability. The reception of the UL TCI state configuration may be performed, e.g., by the TCI state configuration component 846 of the communication manager 832 in the apparatus 802. The activation/deactivation of the TCI state may be performed, e.g., by the TCI state activation component 848 of the communication manager 832 in the apparatus 802, in response to an indication to activate/deactivate the UL TCI state from the base station 102 or 180.

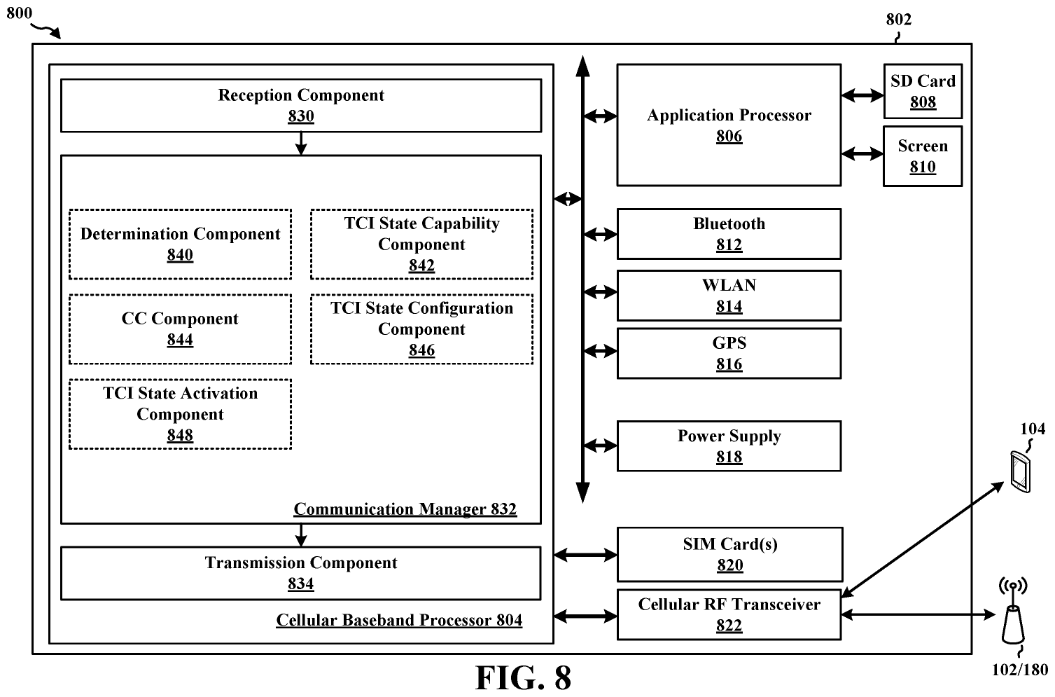

FIG. 8 is a diagram 800 illustrating an example of a hardware implementation for an apparatus 802. The apparatus 802 is a UE and includes a cellular baseband processor 804 (also referred to as a modem) coupled to a cellular RF transceiver 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the cellular RF transceiver 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 350 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see 350 of FIG. 3) and include the additional modules of the apparatus 802.

The communication manager 832 includes a determination component 840 that is configured to determine a UE capability associated with a joint DL and UL TCI state, e.g., as described in connection with 604, and/or to determine a UE capability associated with an UL TCI state, e.g., as described in connection with 704. The communication manager 832 further includes a TCI state capability component 842 that is configured to transmit the UE capability to the base station 102 or 180, e.g., as described in connection with 606 and/or 706. The communication manager 832 further includes a CC component 844 that is configured to receive a configuration of one or more CC lists from a bases station 102 or 180, e.g., as described in connection with 602 and/or 702. The communication manager 832 further includes a TCI state configuration component 846 that is configured to receive a configuration of one or more of a joint DL and UL TCI state and/or one or more UL TCI states, e.g., as described in connection with 608 or 708. The communication manager 832 further includes a TCI state activation component 848 configured to receive an activation of one or more of a joint DL and UL TCI state and/or one or more UL TCI states, e.g., as described in connection with 608 or 708.

The apparatus may include additional components that perform each of the blocks of the algorithm in the aforementioned flowcharts of FIGS. 6 and/or 7 and/or the aspects performed by the UE 402 or 502 in FIGS. 4 and/or 5. As such, each block in the aforementioned flowcharts of FIGS. 6 and/or 7 and/or the aspects performed by the UE 402 or 502 in FIGS. 4 and/or 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, may include means for determining a UE capability associated with a joint DL and UL TCI state indicating a common beam for communication in DL and UL and means for transmitting an indication of the UE capability associated with the joint DL and UL TCI state to a base station. The apparatus 802 may further include means for receiving a configuration of one or more CC lists. The apparatus 802 may further include means for receiving a configuration of one or more joint DL and UL TCI states and/or means for receiving an activation of at least one joint DL and UL TCI state based on the UE capability. The apparatus 802 may include means for determining a UE capability associated with an UL TCI state indicating a common beam for communication in UL and means for transmitting an indication of the UE capability associated with the UL TCI state to a base station. The apparatus 802 may further include means for receiving a configuration of one or more CC lists. The apparatus 802 may further include means for receiving a configuration of one or more UL TCI states and/or means for receiving an activation of at least one UL TCI state based on the UE capability. The aforementioned means may be one or more of the aforementioned components of the apparatus 802 configured to perform the functions recited by the aforementioned means. As described supra, the apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

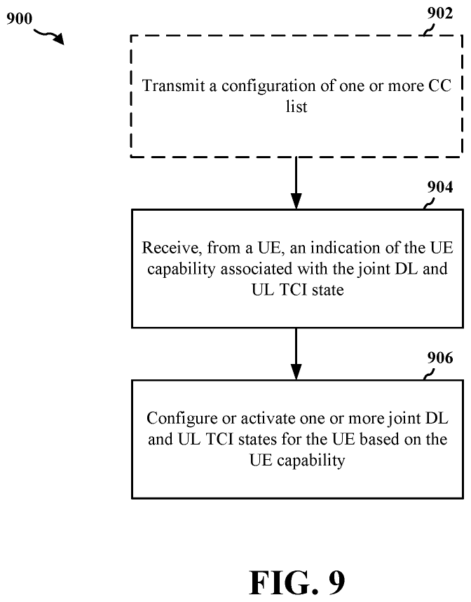

FIG. 9 is a flowchart 900 of a method of wireless communication. The method may be performed by a base station (e.g., the base station 102, 180, 310, 404, or 504; the apparatus 1102. Optional aspects are illustrated with a dashed line. The method may enable the configure and/or activate a joint DL and UL TCI state for the UE based on a UE capability indicated to the base station.

At 904, the base station receives, from a UE, an indication of a UE capability associated with a joint DL and UL TCI state indicating a common beam for communication in DL and UL. The reception of the indication of the UE capability may be performed, e.g., by the TCI state capability component 1142 of the communication manager 1132 of the apparatus 1102. FIG. 4 illustrates an example of a base station 404 receiving a UE capability 409 for a joint DL and UL TCI state.

At 906, the base station configures or activates one or more joint DL and UL TCI state for the UE based on the UE capability. The configuration of the joint DL and UL TCI state may be performed, e.g., by the TCI state configuration component 1146 of the communication manager 1132 in the apparatus 1102. The activation/deactivation of the joint DL and UL TCI state may be performed, e.g., by the TCI state activation component 1148 of the communication manager 1132 in the apparatus 1102. FIG. 4 illustrates an example of a base station 404 configuring and activating one or more joint DL and UL TCI states based on a UE capability.

The UE capability may be for a single TRP and may include at least one of: a first maximum number of configured joint DL and UL TCI states per BWP per CC, a second maximum number of activated joint DL and UL TCI states per BWP per CC, a third maximum number of configured joint DL and UL TCI states across all CCs, or a fourth maximum number of activated joint DL and UL TCI states across all CCs. The UE capability may be for data and control.

As illustrated at 902, the base station may configure one or more CC lists, and the UE capability, received at 904, may be for the third maximum number of configured joint DL and UL TCI states across all CCs in the one or more CC lists or the fourth maximum number of activated joint DL and UL TCI states across all CCs in the one or more CC lists. The configuration of the CC list(s) may be performed, e.g., by the CC component 1144 of the communication manager 1132 of the apparatus 1102.

The UE capability may be for multiple downlink control information (multi-DCI) based multiple TRPs and may include at least one of: a first maximum number of configured joint DL and UL TCI states per CORESET pool index per BWP per CC, a second maximum number of activated joint DL and UL TCI states per CORESET pool index per BWP per CC, a third maximum number of configured joint DL and UL TCI states across all CORESET pool indexes per BWP per CC, a fourth maximum number of activated joint DL and UL TCI states across all CORESET pool indexes per BWP per CC, a fifth maximum number of configured joint DL and UL TCI states per CORESET pool index across all CCs, a sixth maximum number of activated joint DL and UL TCI states per CORESET pool index across all CCs, a seventh maximum number of configured joint DL and UL TCI states across all CORESET pool indexes across all CCs, an eighth maximum number of activated joint DL and UL TCI states across all CORESET pool indexes across all CCs, a first support of a default DL and UL TCI state per CORESET pool index per BWP per CC, or a second support of the default DL and UL TCI state per CORESET pool index across all CCs. The UE capability may be for data and control.

As illustrated at 902, the base station may configure one or more CC lists, and the UE capability, received at 904, may be for the at least one of: the fifth maximum number of configured joint DL and UL TCI states per CORESET pool index across all CCs in the one or more CC lists, the sixth maximum number of activated joint DL and UL TCI states per CORESET pool index across all CCs in the one or more CC lists, the seventh maximum number of configured joint DL and UL TCI states across all CORESET pool indexes across all CCs in the one or more CC lists, the eighth maximum number of activated joint DL and UL TCI states across all CORESET pool indexes across all CCs in the one or more CC lists, or the second support of the default DL and UL TCI state per CORESET pool index across all CCs.

The UE capability may be for single DCI based multiple TRPs and may include at least one of: a maximum number of configured joint DL and UL TCI states mapped to a TCI codepoint for a resource allocation scheme across the multiple TRPs scheduled by a scheduled DCI, first support of a default TCI codepoint mapped to multiple joint DL and UL TCI states per BWP per CC, or second support of the default TCI codepoint mapped to the multiple joint DL and UL TCI states across all CCs. The resource allocation scheme may be based on FDM, SDM, or TDM, for example.

As illustrated at 902, the base station may configure one or more CC lists, and the UE capability, received at 904, may be for the second support of the default TCI codepoint mapped to the multiple joint DL and UL TCI states across all CCs in the one or more CC lists.

The UE capability may be for activation of the joint DL and UL TCI state across multiple CCs. As illustrated at 902, the base station may configure one or more CC lists, and the UE capability, received at 904, may be for the activation of the joint DL and UL TCI state across the multiple CCs of the one or more CC lists.

The UE capability may include an L1 or L2 based inter-cell mobility based on the joint DL and UL TCI state. The UE capability may include support for a reference signal or a channel of a non-serving cell for the joint DL and UL TCI state. The reference signal or the channel of the non-serving cell may provide one or more of a DL quasi co-location assumption or uplink spatial relation information for the joint DL and UL TCI state.

The UE capability may be for an update of the joint DL and UL TCI state via at least one of a MAC-CE or DCI. The UE capability may be for one or more of a PDCCH, a PDSCH scheduled by DCI, an SPS transmission, a PRS, a periodic CSI-RS, an aperiodic CSI-RS, a semi-persistent CSI-RS, a periodic PUCCH, an aperiodic PUCCH, a semi-persistent PUCCH, a PUSCH, an SRS, and/or a PRACH.

The UE capability may be associated with an SRS as a source reference signal. The SRS may be the source reference signal for downlink communication, e.g., downlink only. The joint DL and UL TCI state may indicate a UE spatial reception filter associated with the SRS and based on the UE capability. The SRS may be for one or more of: beam management, codebook based communication, non-codebook based communication, or antenna switching. The joint DL and UL TCI state may indicate the SRS as a QCL type D reference signal. The joint DL and UL TCI state may further include at least one additional reference signal for a different QCL assumption.

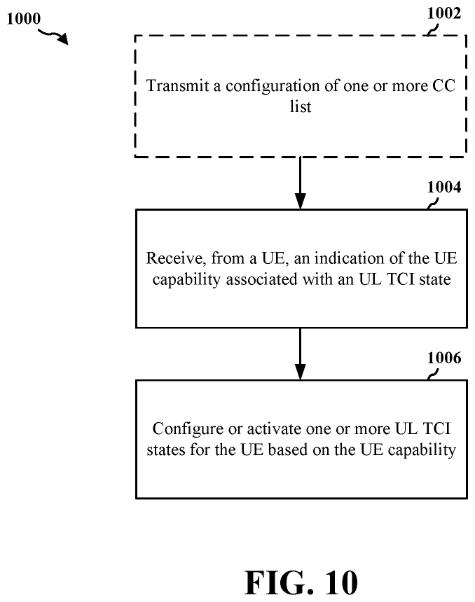

FIG. 10 is a flowchart 1000 of a method of wireless communication. The method may be performed by a base station (e.g., the base station 102, 180, 310, 404, or 504; the apparatus 1102. Optional aspects are illustrated with a dashed line. The method may enable the configure and/or activate an UL TCI state for the UE based on a UE capability indicated to the base station.

At 1004, the base station receives, from a UE, an indication of a UE capability associated with a UL TCI state indicating a common beam for UL communication. The reception of the indication of the UE capability may be performed, e.g., by the TCI state capability component 1142 of the communication manager 1132 of the apparatus 1102. FIG. 4 illustrates an example of a base station 404 receiving a UE capability 409 for a UL TCI state.

At 1006, the base station configures or activates one or more UL TCI state for the UE based on the UE capability. The configuration of the UL TCI state may be performed, e.g., by the TCI state configuration component 1146 of the communication manager 1132 in the apparatus 1102. The activation/deactivation of the UL TCI state may be performed, e.g., by the TCI state activation component 1148 of the communication manager 1132 in the apparatus 1102. FIG. 4 illustrates an example of a base station 404 configuring and activating one or more UL TCI states based on a UE capability.

The UE capability may be for a single TRP and may include at least one of: a first maximum number of configured UL TCI states per BWP per CC, a second maximum number of activated UL TCI states per BWP per CC, a third maximum number of configured UL TCI states across all CCs, or a fourth maximum number of activated UL TCI states across all CCs. The UE capability may be for data and control.

As illustrated at 1002, the base station may configure one or more CC lists, and the UE capability, received at 1004, may be for the third maximum number of configured UL TCI states across all CCs in the one or more CC lists or the fourth maximum number of activated UL TCI states across all CCs in the one or more CC lists. The configuration of the CC list(s) may be performed, e.g., by the CC component 1144 of the communication manager 1132 of the apparatus 1102.

The UE capability may be for multiple downlink control information (multi-DCI) based multiple TRPs and may include at least one of: a first maximum number of configured UL TCI states per CORESET pool index per BWP per CC, a second maximum number of activated UL TCI states per CORESET pool index per BWP per CC, a third maximum number of configured UL TCI states across all CORESET pool indexes per BWP per CC, a fourth maximum number of activated UL TCI states across all CORESET pool indexes per BWP per CC, a fifth maximum number of configured UL TCI states per CORESET pool index across all CCs, a sixth maximum number of activated UL TCI states per CORESET pool index across all CCs, a seventh maximum number of configured UL TCI states across all CORESET pool indexes across all CCs, an eighth maximum number of activated UL TCI states across all CORESET pool indexes across all CCs, a first support of a default UL TCI state per CORESET pool index per BWP per CC, or a second support of the default UL TCI state per CORESET pool index across all CCs. The UE capability may be for data and control.

As illustrated at 1002, the base station may configure one or more CC lists, and the UE capability, received at 1004, may be for the at least one of: the fifth maximum number of configured UL TCI states per CORESET pool index across all CCs in the one or more CC lists, the sixth maximum number of activated UL TCI states per CORESET pool index across all CCs in the one or more CC lists, the seventh maximum number of configured UL TCI states across all CORESET pool indexes across all CCs in the one or more CC lists, the eighth maximum number of activated UL TCI states across all CORESET pool indexes across all CCs in the one or more CC lists, or the second support of the default UL TCI state per CORESET pool index across all CCs.

The UE capability may be for single DCI based multiple TRPs and may include at least one of: a maximum number of configured UL TCI states mapped to a TCI codepoint for a resource allocation scheme across the multiple TRPs scheduled by a scheduled DCI, first support of a default TCI codepoint mapped to multiple UL TCI states per BWP per CC, or second support of the default TCI codepoint mapped to the multiple UL TCI states across all CCs. The resource allocation scheme may be based on FDM, SDM, or TDM, for example.

As illustrated at 1002, the base station may configure one or more CC lists, and the UE capability, received at 1004, may be for the second support of the default TCI codepoint mapped to the multiple UL TCI states across all CCs in the one or more CC lists.

The UE capability may be for activation of the joint DL and UL TCI state across multiple CCs. As illustrated at 1002, the base station may configure one or more CC lists, and the UE capability, received at 1004, may be for the activation of the UL TCI state across the multiple CCs of the one or more CC lists.

The UE capability may include an L1 or L2 based inter-cell mobility based on the UL TCI state. The UE capability may include support for a reference signal or a channel of a non-serving cell for the UL TCI state. The reference signal or the channel of the non-serving cell may provide one or more of a DL quasi co-location assumption or uplink spatial relation information for the UL TCI state.

The UE capability may be for an update of the UL TCI state via at least one of a MAC-CE or DCI. The UE capability may be for one or more of a periodic PUCCH, an aperiodic PUCCH, a semi-persistent PUCCH, a PUSCH, an SRS, and/or a PRACH.

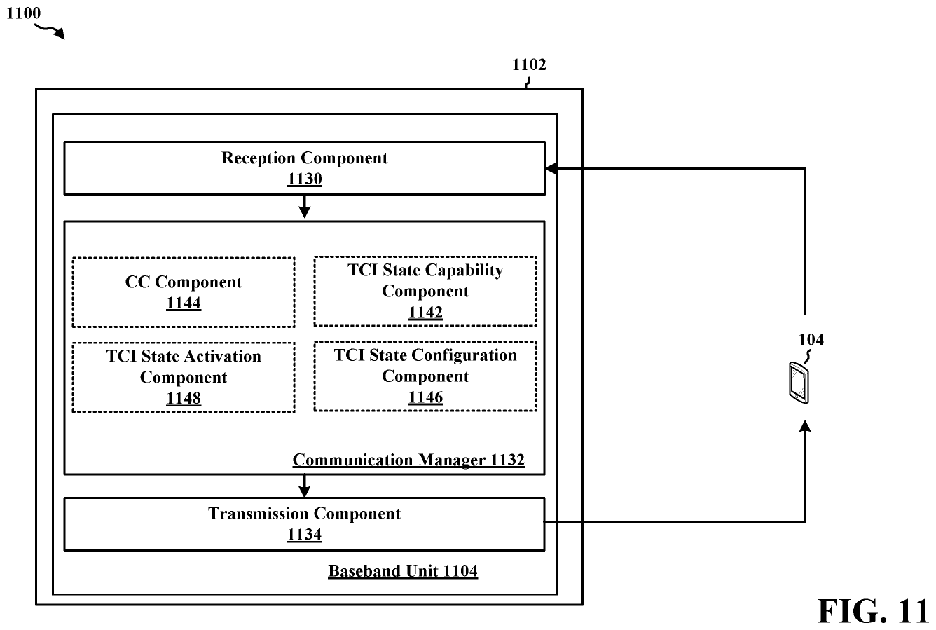

FIG. 11 is a diagram 1100 illustrating an example of a hardware implementation for an apparatus 1102. The apparatus 1102 is a BS and includes a baseband unit 1104. The baseband unit 1104 may communicate through a cellular RF transceiver with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the BS 310 and may include the memory 376 and/or at least one of the TX processor 316, the RX processor 370, and the controller/processor 375.

The communication manager 1132 includes a TCI state capability component 1142 that is configured to receive a UE capability associated with a joint DL and UL TCI state, e.g., as described in connection with 904, and/or to receive a UE capability associated with an UL TCI state, e.g., as described in connection with 1004. The communication manager 1132 further includes a CC component 1144 that is configured to transmit a configuration of one or more CC lists to the UE 104, e.g., as described in connection with 902 and/or 1002. The communication manager 1132 further includes a TCI state configuration component 1146 that is configured to configure one or more of a joint DL and UL TCI state and/or one or more UL TCI states based on the UE capability, e.g., as described in connection with 906 or 1006. The communication manager 1132 further includes a TCI state activation component 1148 configured to activate one or more of a joint DL and UL TCI state and/or one or more UL TCI states based on the UE capability, e.g., as described in connection with 906 and/or 1006.

The apparatus may include additional components that perform each of the blocks of the algorithm in the aforementioned flowcharts of FIGS. 9 and 10 and/or the aspects performed by the base station 404 or 504 in FIGS. 4 and/or 5. As such, each block in the aforementioned flowcharts of FIGS. 9 and 10 and/or the aspects performed by the base station 404 or 504 in FIGS. 4 and/or 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the baseband unit 1104, includes means for may include means for receiving, from a UE, an indication of a UE capability associated with a joint DL and UL TCI state indicating a common beam for communication in DL and UL means for configuring or activating one or more joint DL and UL TCI state for the UE based on the UE capability. The apparatus 1102 may further include means for transmitting a configuration of one or more CC lists. The apparatus 1102 may further include means for receiving, from a UE, an indication of a UE capability associated with an UL TCI state indicating a common beam for UL communication means for configuring or activating one or more UL TCI state for the UE based on the UE capability. The aforementioned means may be one or more of the aforementioned components of the apparatus 1102 configured to perform the functions recited by the aforementioned means. As described supra, the apparatus 1102 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and aspects thereof may be combined with aspects of other embodiments or teaching described herein, without limitation.

Example 1 is a method of wireless communication of a user equipment (UE), comprising: determining a UE capability associated with a joint downlink (DL) and uplink (UL) transmission configuration indicator (TCI) state indicating a common beam for communication in DL and UL; and transmitting an indication of the UE capability associated with the joint DL and UL TCI state to a base station.

In Example 2, the method of Example 1 further includes that the UE capability is for a single transmission reception point (TRP) and includes at least one of: a first maximum number of configured joint DL and UL TCI states per bandwidth part (BWP) per component carrier (CC), a second maximum number of activated joint DL and UL TCI states per BWP per CC, a third maximum number of configured joint DL and UL TCI states across all CCs, or a fourth maximum number of activated joint DL and UL TCI states across all CCs.

In Example 3, the method of Example 1 or Example 2 further includes that the UE capability is for data and control.

In Example 4 the method of any of Examples 1-3 further includes receiving a configuration of one or more CC lists, wherein the UE reports the UE capability for the third maximum number of configured joint DL and UL TCI states across all CCs in the one or more CC lists or the fourth maximum number of activated joint DL and UL TCI states across all CCs in the one or more CC lists.

In Example 5, the method of any of Examples 1˜4 further includes that the UE capability is for multiple downlink control information (multi-DCI) based multiple transmission reception points (TRPs) and includes at least one of: a first maximum number of configured joint DL and UL TCI states per control resource set (CORESET) pool index per bandwidth part (BWP) per component carrier (CC), a second maximum number of activated joint DL and UL TCI states per CORESET pool index per BWP per CC, a third maximum number of configured joint DL and UL TCI states across all CORESET pool indexes per BWP per CC, a fourth maximum number of activated joint DL and UL TCI states across all CORESET pool indexes per BWP per CC, a fifth maximum number of configured joint DL and UL TCI states per CORESET pool index across all CCs, a sixth maximum number of activated joint DL and UL TCI states per CORESET pool index across all CCs, a seventh maximum number of configured joint DL and UL TCI states across all CORESET pool indexes across all CCs, an eighth maximum number of activated joint DL and UL TCI states across all CORESET pool indexes across all CCs, a first support of a default DL and UL TCI state per CORESET pool index per BWP per CC, or a second support of the default DL and UL TCI state per CORESET pool index across all CCs.

In Example 6, the method of any of Examples 1-5 further includes that the UE capability is for data and control.

In Example 7, the method of any of Examples 1-6 further includes receiving a configuration of one or more CC lists, wherein the UE reports the UE capability for at least one of: the fifth maximum number of configured joint DL and UL TCI states per CORESET pool index across all CCs in the one or more CC lists, the sixth maximum number of activated joint DL and UL TCI states per CORESET pool index across all CCs in the one or more CC lists, the seventh maximum number of configured joint DL and UL TCI states across all CORESET pool indexes across all CCs in the one or more CC lists, the eighth maximum number of activated joint DL and UL TCI states across all CORESET pool indexes across all CCs in the one or more CC lists, or the second support of the default DL and UL TCI state per CORESET pool index across all CCs.

In Example 8, the method of any of Examples 1-7 further includes that the UE capability is for single downlink control information (DCI) based multiple transmission reception points (TRPs) and includes at least one of: a maximum number of configured joint DL and UL TCI states mapped to a TCI codepoint for a resource allocation scheme across the multiple TRPs scheduled by a scheduled DCI, first support of a default TCI codepoint mapped to multiple joint DL and UL TCI states per bandwidth part (BWP) per component carrier (CC), or second support of the default TCI codepoint mapped to the multiple joint DL and UL TCI states across all CCs.

In Example 9, the method of any of Examples 1-8 further includes that the resource allocation scheme is based on frequency division multiplexing (FDM), spatial division multiplexing (SDM), or time division multiplexing (TDM).

In Example 10, the method of any of Examples 1-9 further includes receiving a configuration of one or more CC lists, wherein the UE reports the UE capability for the second support of the default TCI codepoint mapped to the multiple joint DL and UL TCI states across all CCs in the one or more CC lists.

In Example 11, the method of any of Examples 1-10 further includes that the UE capability is for activation of the joint DL and UL TCI state across multiple component carriers (CCs).

In Example 12, the method of any of Examples 1-11 further includes receiving a configuration of one or more CC lists, wherein the UE reports the UE capability is for the activation of the joint DL and UL TCI state across the multiple CCs of the one or more CC lists.

In Example 13, the method of any of Examples 1-12 further includes that the UE capability includes a layer 1 (L1) or layer 2 (L2) based inter-cell mobility based on the joint DL and UL TCI state.

In Example 14, the method of any of Examples 1-13 further includes that the UE capability includes support for a reference signal or a channel of a non-serving cell for the joint DL and UL TCI state.

In Example 15, the method of any of Examples 1-14 further includes that the reference signal or the channel of the non-serving cell provides one or more of a DL quasi co-location assumption or uplink spatial relation information for the joint DL and UL TCI state.

In Example 16, the method of any of Examples 1-15 further includes that the UE capability is for an update of the joint DL and UL TCI state via at least one of a medium access control-control element (MAC-CE) or downlink control information (DCI).

In Example 17, the method of any of Examples 1-16 further includes that the UE capability is indicated for one or more of: a physical downlink control channel (PDCCH), a physical downlink shared channel (PDSCH) scheduled by the DCI, a semi-persistent scheduling (SPS) transmission, a periodic channel state information reference signal (CSI-RS), a semi-persistent CSI-RS, an aperiodic CSI-RS, a positioning reference signal, a periodic physical uplink control channel (PUCCH), a semi-persistent PUCCH, an aperiodic PUCCH, a physical uplink shared channel (PUSCH), a sounding reference signal (SRS), or a physical random access channel (PRACH).

In Example 18, the method of any of Examples 1-17 further includes that the UE capability is associated with a sounding reference signal (SRS) as a source reference signal.

In Example 19, the method of any of Examples 1-18 further includes that the SRS is the source reference signal for downlink communication.

In Example 20, the method of any of Examples 1-19 further includes that the joint DL and UL TCI state indicates a UE spatial reception filter associated with the SRS and based on the UE capability.

In Example 21, the method of any of Examples 1-20 further includes that the SRS is for one or more of: beam management, codebook based communication, non-codebook based communication, or antenna switching.

In Example 22, the method of any of Examples 1-21 further includes that the joint DL and UL TCI state indicates the SRS as a quasi co-location (QCL) type D reference signal.

In Example 23, the method of any of Examples 1-22 further includes that the joint DL and UL TCI state further includes at least one additional reference signal for a different QCL assumption.

Example 24 is a device including one or more processors and one or more memories in electronic communication with the one or more processors storing instructions executable by the one or more processors to cause the device to implement a method as in any of Examples 1-23.

Example 25 is a system or apparatus including means for implementing a method or realizing an apparatus as in any of Examples 1-23.

Example 26 is a non-transitory computer readable medium storing instructions executable by one or more processors to cause the one or more processors to implement a method as in any of Examples 1-23.

Example 27 is a method of wireless communication of a user equipment (UE), comprising: determining a UE capability associated with an uplink (UL) transmission configuration indicator (TCI) state; and transmitting an indication of the UE capability associated with the UL TCI state to a base station.

In Example 28, the method of Example 27 further includes that the UE capability is for a single transmission reception point (TRP) and includes at least one of: a first maximum number of configured UL TCI states per bandwidth part (BWP) per component carrier (CC), a second maximum number of activated UL TCI states per BWP per CC, a third maximum number of configured UL TCI states across all CCs, or a fourth maximum number of activated UL TCI states across all CCs.

In Example 29, the method of Example 27 or Example 28 further includes that the UE capability is for data and control.

In Example 30, the method of any of Examples 27-29 further includes receiving a configuration of one or more CC lists, wherein the UE reports the UE capability for the third maximum number of configured UL TCI states across all CCs in the one or more CC lists or the fourth maximum number of activated UL TCI states across all CCs in the one or more CC lists.

In Example 31, the method of any of Examples 27-30 further includes that the UE capability is for multiple downlink control information (multi-DCI) based multiple transmission reception points (TRPs) and includes at least one of: a first maximum number of configured UL TCI states per control resource set (CORESET) pool index per bandwidth part (BWP) per component carrier (CC), a second maximum number of activated UL TCI states per CORESET pool index per BWP per CC, a third maximum number of configured UL TCI states across all CORESET pool indexes per BWP per CC, a fourth maximum number of activated UL TCI states across all CORESET pool indexes per BWP per CC, a fifth maximum number of configured UL TCI states per CORESET pool index across all CCs, a sixth maximum number of activated UL TCI states per CORESET pool index across all CCs, a seventh maximum number of configured UL TCI states across all CORESET pool indexes across all CCs, an eighth maximum number of activated UL TCI states across all CORESET pool indexes across all CCs, a first support of a default UL TCI state per CORESET pool index per BWP per CC, or a second support of the default UL TCI state per CORESET pool index across all CCs.

In Example 32, the method of any of Examples 27-31 further includes that the UE capability is for data and control.

In Example 33, the method of any of Examples 27-32 further includes receiving a configuration of one or more CC lists, wherein the UE reports the UE capability for at least one of: the fifth maximum number of configured UL TCI states per CORESET pool index across all CCs in the one or more CC lists, the sixth maximum number of activated UL TCI states per CORESET pool index across all CCs in the one or more CC lists, the seventh maximum number of configured UL TCI states across all CORESET pool indexes across all CCs in the one or more CC lists, the eighth maximum number of activated UL TCI states across all CORESET pool indexes across all CCs in the one or more CC lists, or the second support of the default UL TCI state per CORESET pool index across all CCs.

In Example 34, the method of any of Examples 27-33 further includes that the UE capability is for single downlink control information (DCI) based multiple transmission reception points (TRPs) and includes at least one of: a maximum number of configured UL TCI states mapped to a TCI codepoint for a resource allocation scheme across the multiple TRPs scheduled by a scheduled DCI, first support of a default TCI codepoint mapped to multiple UL TCI states per bandwidth part (BWP) per component carrier (CC), or second support of the default TCI codepoint mapped to the multiple UL TCI states across all CCs.

In Example 35, the method of any of Examples 27-34 further includes that the resource allocation scheme is based on frequency division multiplexing (FDM), spatial division multiplexing (SDM), or time division multiplexing (TDM).

In Example 36, the method of any of Examples 27-35 further includes receiving a configuration of one or more CC lists, wherein the UE reports the UE capability for the second support of the default TCI codepoint mapped to the multiple UL TCI states across all CCs in the one or more CC lists.

In Example 37, the method of any of Examples 27-36 further includes that the UE capability is for activation of the UL TCI state across multiple component carriers (CCs).

In Example 38, the method of any of Examples 27-37 further includes receiving a configuration of one or more CC lists, wherein the UE reports the UE capability is for the activation of the UL TCI state across the multiple CCs of the one or more CC lists.

In Example 39, the method of any of Examples 27-38 further includes that the UE capability includes a layer 1 (L1) or layer 2 (L2) based inter-cell mobility based on the UL TCI state.

In Example 40, the method of any of Examples 27-39 further includes that the UE capability includes support for a reference signal or a channel of a non-serving cell for the UL TCI state.

In Example 41, the method of any of Examples 27-40 further includes that the reference signal or the channel of the non-serving cell provides one or more of a DL quasi co-location assumption or uplink spatial relation information for the UL TCI state.

In Example 42, the method of any of Examples 27-41 further includes that the UE capability is for an update of the UL TCI state via at least one of a medium access control-control element (MAC-CE) or downlink control information (DCI).

In Example 43, the method of any of Examples 27-42 further includes that the UE capability is indicated for one or more of: a periodic physical uplink control channel (PUCCH), a semi-persistent PUCCH, an aperiodic PUCCH, a physical uplink shared channel (PUSCH), a sounding reference signal (SRS), or physical random access channel (PRACH).

Example 44 is a device including one or more processors and one or more memories in electronic communication with the one or more processors storing instructions executable by the one or more processors to cause the device to implement a method as in any of Examples 27-43.

Example 45 is a system or apparatus including means for implementing a method or realizing an apparatus as in any of Examples 27-43.

Example 46 is a non-transitory computer readable medium storing instructions executable by one or more processors to cause the one or more processors to implement a method as in any of Examples 27-43.

Example 47 is a method of wireless communication of a base station, comprising:

receiving, from a UE, an indication of a UE capability associated with a joint downlink (DL) and uplink (UL) transmission configuration indicator (TCI) state indicating a common beam for communication in DL and UL; and configuring or activating one or more joint DL and UL TCI state for the UE based on the UE capability.

In Example 48, the method of Example 47 further includes that the UE capability is for a single transmission reception point (TRP) and includes at least one of: a first maximum number of configured joint DL and UL TCI states per bandwidth part (BWP) per component carrier (CC), a second maximum number of activated joint DL and UL TCI states per BWP per CC, a third maximum number of configured joint DL and UL TCI states across all CCs, or a fourth maximum number of activated joint DL and UL TCI states across all CCs.

In Example 49, the method of Example 47 or 48 further includes that the UE capability is for data and control.

In Example 50, the method of any of Examples 47-49 further includes transmitting a configuration of one or more CC lists, wherein the UE capability is received for the third maximum number of configured joint DL and UL TCI states across all CCs in the one or more CC lists or the fourth maximum number of activated joint DL and UL TCI states across all CCs in the one or more CC lists.

In Example 51, the method of any of Examples 47-50 further includes that the UE capability is for multiple downlink control information (multi-DCI) based multiple transmission reception points (TRPs) and includes at least one of: a first maximum number of configured joint DL and UL TCI states per control resource set (CORESET) pool index per bandwidth part (BWP) per component carrier (CC), a second maximum number of activated joint DL and UL TCI states per CORESET pool index per BWP per CC, a third maximum number of configured joint DL and UL TCI states across all CORESET pool indexes per BWP per CC, a fourth maximum number of activated joint DL and UL TCI states across all CORESET pool indexes per BWP per CC, a fifth maximum number of configured joint DL and UL TCI states per CORESET pool index across all CCs, a sixth maximum number of activated joint DL and UL TCI states per CORESET pool index across all CCs, a seventh maximum number of configured joint DL and UL TCI states across all CORESET pool indexes across all CCs, an eighth maximum number of activated joint DL and UL TCI states across all CORESET pool indexes across all CCs, a first support of a default DL and UL TCI state per CORESET pool index per BWP per CC, or a second support of the default DL and UL TCI state per CORESET pool index across all CCs.

In Example 52, the method of any of Examples 47-51 further includes that the UE capability is for data and control.

In Example 53, the method of any of Examples 47-52 further includes transmitting a configuration of one or more CC lists, wherein the UE capability is received for at least one of: the fifth maximum number of configured joint DL and UL TCI states per CORESET pool index across all CCs in the one or more CC lists, the sixth maximum number of activated joint DL and UL TCI states per CORESET pool index across all CCs in the one or more CC lists, the seventh maximum number of configured joint DL and UL TCI states across all CORESET pool indexes across all CCs in the one or more CC lists, the eighth maximum number of activated joint DL and UL TCI states across all CORESET pool indexes across all CCs in the one or more CC lists, or the second support of the default DL and UL TCI state per CORESET pool index across all CCs.

In Example 54, the method of any of Examples 47-53 further includes that the UE capability is for single downlink control information (DCI) based multiple transmission reception points (TRPs) and includes at least one of: a maximum number of configured joint DL and UL TCI states mapped to a TCI codepoint for a resource allocation scheme across the multiple TRPs scheduled by a scheduled DCI, first support of a default TCI codepoint mapped to multiple joint DL and UL TCI states per bandwidth part (BWP) per component carrier (CC), or second support of the default TCI codepoint mapped to the multiple joint DL and UL TCI states across all CCs.

In Example 55, the method of any of Examples 47-54 further includes that the resource allocation scheme is based on frequency division multiplexing (FDM), spatial division multiplexing (SDM), or time division multiplexing (TDM).

In Example 56, the method of any of Examples 47-55 further includes transmitting a configuration of one or more CC lists, wherein the UE capability is received for the second support of the default TCI codepoint mapped to the multiple joint DL and UL TCI states across all CCs in the one or more CC lists.

In Example 57, the method of any of Examples 47-56 further includes that the UE capability is for activation of the joint DL and UL TCI state across multiple component carriers (CCs).

In Example 58, the method of any of Examples 47-57 further includes transmitting a configuration of one or more CC lists, wherein the UE capability is received for the activation of the joint DL and UL TCI state across the multiple CCs of the one or more CC lists.

In Example 59, the method of any of Examples 47-58 further includes that the UE capability includes a layer 1 (L1) or layer 2 (L2) based inter-cell mobility based on the joint DL and UL TCI state.

In Example 60, the method of any of Examples 47-59 further includes that the UE capability includes support for a reference signal or a channel of a non-serving cell for the joint DL and UL TCI state.

In Example 61, the method of any of Examples 47-60 further includes that the reference signal or the channel of the non-serving cell provides one or more of a DL quasi co-location assumption or uplink spatial relation information for the joint DL and UL TCI state.

In Example 62, the method of any of Examples 47-61 further includes that the UE capability is for an update of the joint DL and UL TCI state via at least one of a medium access control-control element (MAC-CE) or downlink control information (DCI).

In Example 63, the method of any of Examples 47-62 further includes that the UE capability is indicated for one or more of: a physical downlink control channel (PDCCH), a physical downlink shared channel (PDSCH) scheduled by the DCI, a semi-persistent scheduling (SPS) transmission, a periodic channel state information reference signal (CSI-RS), a semi-persistent CSI-RS, an aperiodic CSI-RS, a positioning reference signal, a periodic physical uplink control channel (PUCCH), a semi-persistent PUCCH, an aperiodic PUCCH, a physical uplink shared channel (PUSCH), a sounding reference signal (SRS), or physical random access channel (PRACH).

In Example 64, the method of any of Examples 47-63 further includes that the UE capability is associated with a sounding reference signal (SRS) as a source reference signal.

In Example 65, the method of any of Examples 47-64 further includes that the SRS is the source reference signal for downlink communication.

In Example 66, the method of any of Examples 47-65 further includes that the joint

DL and UL TCI state indicates a UE spatial reception filter associated with the SRS and based on the UE capability.

In Example 67, the method of any of Examples 47-66 further includes that the SRS is for one or more of: beam management, codebook based communication, non-codebook based communication, or antenna switching.

In Example 68, the method of any of Examples 47-67 further includes that the joint

DL and UL TCI state indicates the SRS as a quasi co-location (QCL) type D reference signal.

In Example 69, the method of any of Examples 47-68 further includes that the joint

DL and UL TCI state further includes at least one additional reference signal for a different QCL assumption.

Example 70 is a device including one or more processors and one or more memories in electronic communication with the one or more processors storing instructions executable by the one or more processors to cause the device to implement a method as in any of Examples 47-69.

Example 71 is a system or apparatus including means for implementing a method or realizing an apparatus as in any of Examples 47-69.

Example 72 is a non-transitory computer readable medium storing instructions executable by one or more processors to cause the one or more processors to implement a method as in any of Examples 47-69.

Example 73 is a method of wireless communication of a base station, comprising: receiving, from a UE, an indication of a UE capability associated with an uplink (UL) transmission configuration indicator (TCI) state indicating a common beam for communication in DL and UL; and configuring or activating one or more UL TCI state for the UE based on the UE capability.

In Example 74, the method of Example 73 further includes that the UE capability is for a single transmission reception point (TRP) and includes at least one of: a first maximum number of configured UL TCI states per bandwidth part (BWP) per component carrier (CC), a second maximum number of activated UL TCI states per BWP per CC, a third maximum number of configured UL TCI states across all CCs, or a fourth maximum number of activated UL TCI states across all CCs.

In Example 75, the method of Example 73 or Example 74 further includes that the UE capability is for data and control.

In Example 76, the method of any of Examples 73-75 further includes transmitting a configuration of one or more CC lists, wherein the UE capability is received for the third maximum number of configured UL TCI states across all CCs in the one or more CC lists or the fourth maximum number of activated UL TCI states across all CCs in the one or more CC lists.

In Example 77, the method of any of Examples 73-76 further includes that the UE capability is for multiple downlink control information (multi-DCI) based multiple transmission reception points (TRPs) and includes at least one of: a first maximum number of configured UL TCI states per control resource set (CORESET) pool index per bandwidth part (BWP) per component carrier (CC), a second maximum number of activated UL TCI states per CORESET pool index per BWP per CC, a third maximum number of configured UL TCI states across all CORESET pool indexes per BWP per CC, a fourth maximum number of activated UL TCI states across all CORESET pool indexes per BWP per CC, a fifth maximum number of configured UL TCI states per CORESET pool index across all CCs, a sixth maximum number of activated UL TCI states per CORESET pool index across all CCs, a seventh maximum number of configured UL TCI states across all CORESET pool indexes across all CCs, an eighth maximum number of activated UL TCI states across all CORESET pool indexes across all CCs, a first support of a default UL TCI state per CORESET pool index per BWP per CC, or a second support of the default UL TCI state per CORESET pool index across all CCs.

In Example 78, the method of any of Examples 73-77 further includes that the UE capability is for data and control.

In Example 79, the method of any of Examples 73-78 further includes transmitting a configuration of one or more CC lists, wherein the UE capability is received for at least one of: the fifth maximum number of configured UL TCI states per CORESET pool index across all CCs in the one or more CC lists, the sixth maximum number of activated UL TCI states per CORESET pool index across all CCs in the one or more CC lists, the seventh maximum number of configured UL TCI states across all CORESET pool indexes across all CCs in the one or more CC lists, the eighth maximum number of activated UL TCI states across all CORESET pool indexes across all CCs in the one or more CC lists, or the second support of the default UL TCI state per CORESET pool index across all CCs.

In Example 80, the method of any of Examples 73-79 further includes that the UE capability is for single downlink control information (DCI) based multiple transmission reception points (TRPs) and includes at least one of: a maximum number of configured UL TCI states mapped to a TCI codepoint for a resource allocation scheme across the multiple TRPs scheduled by a scheduled DCI, first support of a default TCI codepoint mapped to multiple UL TCI states per bandwidth part (BWP) per component carrier (CC), or second support of the default TCI codepoint mapped to the multiple UL TCI states across all CCs.

In Example 81, the method of any of Examples 73-80 further includes that the resource allocation scheme is based on frequency division multiplexing (FDM), spatial division multiplexing (SDM), or time division multiplexing (TDM).

In Example 82, the method of any of Examples 73-81 further includes transmitting a configuration of one or more CC lists, wherein the UE capability is received for the second support of the default TCI codepoint mapped to the multiple UL TCI states across all CCs in the one or more CC lists.

In Example 83, the method of any of Examples 73-82 further includes that the UE capability is for activation of the UL TCI state across multiple component carriers (CCs).

In Example 84, the method of any of Examples 73-83 further includes transmitting a configuration of one or more CC lists, wherein the UE capability is received for the activation of the UL TCI state across the multiple CCs of the one or more CC lists.

In Example 85, the method of any of Examples 73-84 further includes that the UE capability includes a layer 1 (L1) or layer 2 (L2) based inter-cell mobility based on the UL TCI state.

In Example 86, the method of any of Examples 73-85 further includes that the UE capability includes support for a reference signal or a channel of a non-serving cell for the UL TCI state.

In Example 87, the method of any of Examples 73-86 further includes that the reference signal or the channel of the non-serving cell provides one or more of a DL quasi co-location assumption or uplink spatial relation information for the UL TCI state.

In Example 88, the method of any of Examples 73-87 further includes that the UE capability is for an update of the UL TCI state via at least one of a medium access control-control element (MAC-CE) or downlink control information (DCI).

In Example 89, the method of any of Examples 73-88 further includes that the UE capability is indicated for one or more of: a periodic physical uplink control channel (PUCCH), a semi-persistent PUCCH, an aperiodic PUCCH, a physical uplink shared channel (PUSCH), a sounding reference signal (SRS), or a physical random access channel (PRACH).

Example 90 is a device including one or more processors and one or more memories in electronic communication with the one or more processors storing instructions executable by the one or more processors to cause the device to implement a method as in any of Examples 73-89.

Example 91 is a system or apparatus including means for implementing a method or realizing an apparatus as in any of Examples 73-89.

Example 92 is a non-transitory computer readable medium storing instructions executable by one or more processors to cause the one or more processors to implement a method as in any of Examples 73-89.

1. A method of wireless communication of a user equipment (UE), comprising:
determining a UE capability associated with a joint downlink (DL) and uplink (UL) transmission configuration indicator (TCI) state indicating a common beam for communication in DL and UL; and
transmitting an indication of the UE capability associated with the joint DL and UL TCI state to a base station.

2. The method of claim 1, wherein the UE capability is for a single transmission reception point (TRP) and includes at least one of:
a first maximum number of configured joint DL and UL TCI states per bandwidth part (BWP) per component carrier (CC),
a second maximum number of activated joint DL and UL TCI states per BWP per CC,
a third maximum number of configured joint DL and UL TCI states across all CCs, or
a fourth maximum number of activated joint DL and UL TCI states across all CCs.

3. (canceled)

4. The method of claim 2, further comprising:
receiving a configuration of one or more CC lists, wherein the UE reports the UE capability for the third maximum number of configured joint DL and UL TCI states across all CCs in the one or more CC lists or the fourth maximum number of activated joint DL and UL TCI states across all CCs in the one or more CC lists.

5. The method of claim 1, wherein the UE capability is for multiple downlink control information (multi-DCI) based multiple transmission reception points (TRPs) and includes at least one of:
a first maximum number of configured joint DL and UL TCI states per control resource set (CORESET) pool index per bandwidth part (BWP) per component carrier (CC),
a second maximum number of activated joint DL and UL TCI states per CORESET pool index per BWP per CC,
a third maximum number of configured joint DL and UL TCI states across all CORESET pool indexes per BWP per CC,
a fourth maximum number of activated joint DL and UL TCI states across all CORESET pool indexes per BWP per CC,
a fifth maximum number of configured joint DL and UL TCI states per CORESET pool index across all CCs,
a sixth maximum number of activated joint DL and UL TCI states per CORESET pool index across all CCs,
a seventh maximum number of configured joint DL and UL TCI states across all CORESET pool indexes across all CCs,
an eighth maximum number of activated joint DL and UL TCI states across all CORESET pool indexes across all CCs,
a first support of a default DL and UL TCI state per CORESET pool index per BWP per CC, or
a second support of the default DL and UL TCI state per CORESET pool index across all CCs.

6. (canceled)

7. (canceled)

8. The method of claim 1, wherein the UE capability is for single downlink control information (DCI) based multiple transmission reception points (TRPs) and includes at least one of:
a maximum number of configured joint DL and UL TCI states mapped to a TCI codepoint for a resource allocation scheme across the multiple TRPs scheduled by a scheduled DCI,
first support of a default TCI codepoint mapped to multiple joint DL and UL TCI states per bandwidth part (BWP) per component carrier (CC), or
second support of the default TCI codepoint mapped to the multiple joint DL and UL TCI states across all CCs.

9. (canceled)

10. The method of claim 8, further comprising:
receiving a configuration of one or more CC lists, wherein the UE reports the UE capability for the second support of the default TCI codepoint mapped to the multiple joint DL and UL TCI states across all CCs in the one or more CC lists.

11. The method of claim 1, wherein the UE capability is for activation of the joint DL and UL TCI state across multiple component carriers (CCs).

12. The method of claim 11, further comprising:
receiving a configuration of one or more CC lists, wherein the UE reports the UE capability is for the activation of the joint DL and UL TCI state across the multiple CCs of the one or more CC lists.

13-15. (canceled)

16. The method of claim 1, wherein the UE capability is for an update of the joint DL and UL TCI state via at least one of a medium access control-control element (MAC-CE) or downlink control information (DCI).

17-23. (canceled)

24. An apparatus for wireless communication of a user equipment (UE), comprising:
means for determining a UE capability associated with a joint downlink (DL) and uplink (UL) transmission configuration indicator (TCI) state indicating a common beam for communication in DL and UL; and
means for transmitting an indication of the UE capability associated with the joint DL and UL TCI state to a base station.

25. (canceled)

26. An apparatus for wireless communication at a user equipment (UE), comprising:
a memory; and
at least one processor coupled to the memory and configured to:
determine a UE capability associated with a joint downlink (DL) and uplink (UL) transmission configuration indicator (TCI) state indicating a common beam for communication in DL and UL; and
transmit an indication of the UE capability associated with the joint DL and UL TCI state to a base station.

27. (canceled)

28. A method of wireless communication of a user equipment (UE), comprising:
determining a UE capability associated with an uplink (UL) transmission configuration indicator (TCI) state; and
transmitting an indication of the UE capability associated with the UL TCI state to a base station.

29. The method of claim 28, wherein the UE capability is for a single transmission reception point (TRP) and includes at least one of:
a first maximum number of configured UL TCI states per bandwidth part (BWP) per component carrier (CC),
a second maximum number of activated UL TCI states per BWP per CC,
a third maximum number of configured UL TCI states across all CCs, or
a fourth maximum number of activated UL TCI states across all CCs.

30. The method of claim 29, wherein the UE capability is for data and control.

31. The method of claim 29, further comprising:
receiving a configuration of one or more CC lists, wherein the UE reports the UE capability for the third maximum number of configured UL TCI states across all CCs in the one or more CC lists or the fourth maximum number of activated UL TCI states across all CCs in the one or more CC lists.

32. The method of claim 28, wherein the UE capability is for multiple downlink control information (multi-DCI) based multiple transmission reception points (TRPs) and includes at least one of:
a first maximum number of configured UL TCI states per control resource set (CORESET) pool index per bandwidth part (BWP) per component carrier (CC),
a second maximum number of activated UL TCI states per CORESET pool index per BWP per CC,
a third maximum number of configured UL TCI states across all CORESET pool indexes per BWP per CC,
a fourth maximum number of activated UL TCI states across all CORESET pool indexes per BWP per CC,
a fifth maximum number of configured UL TCI states per CORESET pool index across all CCs,
a sixth maximum number of activated UL TCI states per CORESET pool index across all CCs,
a seventh maximum number of configured UL TCI states across all CORESET pool indexes across all CCs,
an eighth maximum number of activated UL TCI states across all CORESET pool indexes across all CCs,
a first support of a default UL TCI state per CORESET pool index per BWP per CC, or
a second support of the default UL TCI state per CORESET pool index across all CCs.

33. (canceled)

34. The method of claim 32, further comprising:
receiving a configuration of one or more CC lists, wherein the UE reports the UE capability for at least one of:
the fifth maximum number of configured UL TCI states per CORESET pool index across all CCs in the one or more CC lists,
the sixth maximum number of activated UL TCI states per CORESET pool index across all CCs in the one or more CC lists,
the seventh maximum number of configured UL TCI states across all CORESET pool indexes across all CCs in the one or more CC lists,
the eighth maximum number of activated UL TCI states across all CORESET pool indexes across all CCs in the one or more CC lists, or
the second support of the default UL TCI state per CORESET pool index across all CCs.

35. The method of claim 28, wherein the UE capability is for single downlink control information (DCI) based multiple transmission reception points (TRPs) and includes at least one of:
a maximum number of configured UL TCI states mapped to a TCI codepoint for a resource allocation scheme across the multiple TRPs scheduled by a scheduled DCI,
first support of a default TCI codepoint mapped to multiple UL TCI states per bandwidth part (BWP) per component carrier (CC), or
second support of the default TCI codepoint mapped to the multiple UL TCI states across all CCs.

36. The method of claim 35, wherein the resource allocation scheme is based on frequency division multiplexing (FDM), spatial division multiplexing (SDM), or time division multiplexing (TDM).

37. The method of claim 35, further comprising:
receiving a configuration of one or more CC lists, wherein the UE reports the UE capability for the second support of the default TCI codepoint mapped to the multiple UL TCI states across all CCs in the one or more CC lists.

38. The method of claim 28, wherein the UE capability is for activation of the UL TCI state across multiple component carriers (CCs).

39. The method of claim 38, further comprising:
receiving a configuration of one or more CC lists, wherein the UE reports the UE capability is for the activation of the UL TCI state across the multiple CCs of the one or more CC lists.

40. The method of claim 28, wherein the UE capability includes a layer 1 (L1) or layer 2 (L2) based inter-cell mobility based on the UL TCI state.

41. The method of claim 40, wherein the UE capability includes support for a reference signal or a channel of a non-serving cell for the UL TCI state.

42. The method of claim 41, wherein the reference signal or the channel of the non-serving cell provides one or more of a DL quasi co-location assumption or uplink spatial relation information for the UL TCI state.

43. The method of claim 28, wherein the UE capability is for an update of the UL TCI state via at least one of a medium access control-control element (MAC-CE) or downlink control information (DCI).

44. The method of claim 43, wherein the UE capability is indicated for one or more of:
a periodic physical uplink control channel (PUCCH),
a semi-persistent PUCCH,
an aperiodic PUCCH,
a physical uplink shared channel (PUSCH),
a sounding reference signal (SRS), or
physical random access channel (PRACH).

45. (canceled)

46. (canceled)

47. An apparatus for wireless communication at a user equipment (UE), comprising:
a memory; and
at least one processor coupled to the memory and configured to:
determine a UE capability associated with an uplink (UL) transmission configuration indicator (TCI) state; and
transmit an indication of the UE capability associated with the UL TCI state to a base station.

48-96. (canceled)

97. The apparatus of claim 26, wherein the UE capability is for a single transmission reception point (TRP) and includes at least one of:
a first maximum number of configured joint DL and UL TCI states per bandwidth part (BWP) per component carrier (CC),
a second maximum number of activated joint DL and UL TCI states per BWP per CC,
a third maximum number of configured joint DL and UL TCI states across all CCs, or
a fourth maximum number of activated joint DL and UL TCI states across all CCs.

98. The apparatus of claim 97, wherein the at least one processor is further configured to receive a configuration of one or more CC lists, wherein the UE reports the UE capability for the third maximum number of configured joint DL and UL TCI states across all CCs in the one or more CC lists or the fourth maximum number of activated joint DL and UL TCI states across all CCs in the one or more CC lists.

99. The apparatus of claim 98, wherein the UE capability is for single downlink control information (DCI) based multiple transmission reception points (TRPs) and includes at least one of:
a maximum number of configured joint DL and UL TCI states mapped to a TCI codepoint for a resource allocation scheme across the multiple TRPs scheduled by a scheduled DCI,
first support of a default TCI codepoint mapped to multiple joint DL and UL TCI states per bandwidth part (BWP) per component carrier (CC), or
second support of the default TCI codepoint mapped to the multiple joint DL and UL TCI states across all CCs.

100. The apparatus of claim 47, wherein the UE capability is for a single transmission reception point (TRP) and includes at least one of:
a first maximum number of configured UL TCI states per bandwidth part (BWP) per component carrier (CC),
a second maximum number of activated UL TCI states per BWP per CC,
a third maximum number of configured UL TCI states across all CCs, or
a fourth maximum number of activated UL TCI states across all CCs.

101. The apparatus of claim 100, where the at least one processor is further configured to:
receive a configuration of one or more CC lists, wherein the UE reports the UE capability for the third maximum number of configured UL TCI states across all CCs in the one or more CC lists or the fourth maximum number of activated UL TCI states across all CCs in the one or more CC lists.

102. The apparatus of claim 47, wherein the UE capability is for single downlink control information (DCI) based multiple transmission reception points (TRPs) and includes at least one of:
a maximum number of configured UL TCI states mapped to a TCI codepoint for a resource allocation scheme across the multiple TRPs scheduled by a scheduled DCI,
first support of a default TCI codepoint mapped to multiple UL TCI states per bandwidth part (BWP) per component carrier (CC), or
second support of the default TCI codepoint mapped to the multiple UL TCI states across all CCs.
